(19) United States
(12) Patent Application Publication
(10) Pub. No.: US 2011/0108684 A1
(43) Pub. Date: May 12, 2011

(54) Screen stand with a flat screen

(75) Inventor: Christian Roessler, Frankfurt/M. (DE)

(73) Assignee: IMPULS VERWALTUNGS-UND BETEILIGUNGS GMBH & CO. KG, FRANKFURT AM MAIN (DE)

(21) Appl. No.: 12/802,293

(22) Filed: Jun. 3, 2010

(30) Foreign Application Priority Data
Nov. 12, 2009 (DE) 20 2009 015 421.1

(51) Int. Cl. F16M 11/02; F16M 11/22

(52) U.S. Cl. 248/176.1

(57) ABSTRACT

In a screen stand, a flat screen is held in a holder having side bars and crossbars. A faceplate borders on the flat screen. The crossbars are adjustable in their length and their position relative to the side bars. The screen stand has a foot and the holder supports the flat screen on the foot.

### CROSS REFERENCE TO RELATED APPLICATIONS

Applicant claims priority under 35 U.S.C. §119 of German Application No. 20 2009 015 421.1 filed Nov. 12, 2009.

### BACKGROUND OF THE INVENTION

1. Field of the Invention

The invention relates to a screen stand with a flat screen, having a foot and a holder for supporting the flat screen on the foot.

2. The Prior Art

Such screen stands with flat screens are frequently used in trade show booths or in sales rooms for presentation of goods and services and are known from practice. For example, the holder in screen stands known from practice is frequently configured as a column. Such screen stands, however, are suitable only in limited manner for directing the observer's view to the display of the flat screen.

### SUMMARY OF THE INVENTION

It is an object of the invention to provide a screen stand of the type stated initially that avoids optical influences on an observer that divert from the display of the flat screen.

These and other objects are achieved, according to the invention, by providing a screen stand in which the holder has two side bars that enclose the flat screen laterally, the side bars are connected with one another by way of crossbars, and a section between flat screen and foot has a faceplate on a front side.

Via this configuration, the flat screen is framed by the side bars and the faceplate. As a result, the observer's view is blocked past the flat screen, underneath and at the sides. Furthermore, possibly disruptive connecting cables are covered up by the faceplate. In this way, the screen stand according to the invention avoids distractions from the display of the flat screen. Thanks to the invention, the observer's view is directed at the display of the flat screen. The screen stand according to the invention is furthermore suitable as a decorative panel in trade show and sales booths.

The screen stand according to the invention is able to further illustrate the information displayed on the flat screen or to provide the observer with additional information, if the panel has a display board. In the simplest case, the display board is a poster wall that displays the logo of a company or the product shown on the flat screen.

The screen stand according to the invention can be put together, in simple manner, from individual parts, if the side bars have at least two side-bar sections that are releasably connected with one another, if one of the side-bar sections extends beyond the height of the flat screen, and the other one of the side-bar sections is connected with the foot. This configuration furthermore allows space-saving storage of the screen stand according to the invention.

The screen stand according to the invention can be used in particularly multi-faceted manner if an intermediate element is inserted between the side-bar sections and separates the flat screen from the faceplate that lies underneath. This intermediate element can have a shelf for brochures or documents, for example. Furthermore, the intermediate element allows adaptation of the height of the flat screen to the intended purpose of use.

It contributes to a further increase in the multi-faceted nature of the screen stand according to the invention if a head element is attached on the ends of the side bars that face away from the foot and ends flush with the flat screen. A camera can be inserted into this head element, for example, or another faceplate can be attached.

The screen stand according to the invention can be equipped with different flat screens if the crossbars are adjustable in their length and/or in their position relative to the side bars. Via this configuration, different flat screens can be set so that the front side of the flat screen, in each instance, ends with the side bars.

Assembly of the screen stand according to the invention can be configured in particularly simple manner if the side bars have pockets for accommodating edges of the faceplate, a back wall and/or the frame of the flat screen.

It contributes to further simplification of the assembly of the screen stand according to the invention if the side bars have longitudinal guides that face one another and if the crossbars are attached in the longitudinal guides.

The screen stand according to the invention can be put together, in simple manner, in multiple desired sizes, if the side-bar sections are attached in the longitudinal guides and/or second longitudinal guides of the adjacent side-bar section. As a result, the screen stand according to the invention furthermore has particularly great stability.

It contributes to a further increase in the stability of the screen stand according to the invention if the side bars have a closed box profile.

The screen stand according to the invention has a smooth surface if the second longitudinal guides are disposed on the inside of the box profile of the side bars.

The side bars are able to make a clear contribution to the appearance of the screen stand according to the invention if the side bars have a longitudinal groove for accommodating a light strip on their outside.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 is a perspective representation of a screen stand according to the invention, with a flat screen;

FIG. 2 shows a holder of the screen stand from FIG. 1;

FIG. 3 is an extended representation of a connection of crossbars to side bars of the holder of the screen stand;

FIG. 4 is a top view of the holder of the screen stand with the flat screen;

FIG. 5 shows another embodiment of the holder of the screen stand;

FIG. 6 shows an embodiment of the screen stand according to the invention with an intermediate element;

FIG. 7 shows another embodiment of the screen stand according to the invention with an intermediate element;

FIG. 8 shows an embodiment of the screen stand according to the invention with a head element;

FIG. 9 shows another embodiment of the holder of the screen stand;

FIG. 10 is an enlarged representation of the connection of two side-bar sections of the holder of the screen stand from FIG. 9; and

FIG. 11 is a sectional representation of a side bar of the holder from FIG. 9, with adjacent regions of a metal sheet and a back wall of the screen stand.

### DETAILED DESCRIPTION OF PREFERRED EMBODIMENTS

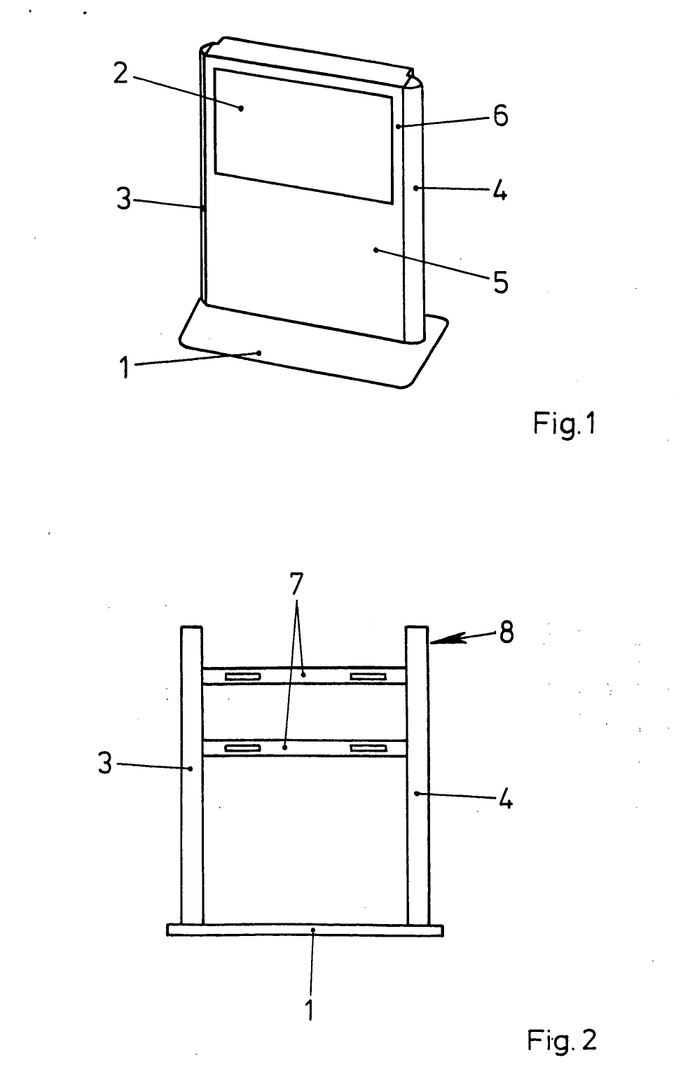

Referring now in detail to the drawings, FIG. 1 shows a front side of a screen stand, with a foot 1 and a flat screen 2. The screen stand has side bars 3, 4 that extend over its entire height, and a faceplate 5 disposed between flat screen 2 and foot 1. Side bars 3, 4 end flush with faceplate 5 and a frame 6 that encloses flat screen 2. A frameless flat screen, not shown, could, of course, end flush with side bars 3, 4. Faceplate 5 can be configured as a display board and display additional information.

FIG. 2 shows the screen stand from FIG. 1 without a faceplate 5 and flat screen 2. Here, it can be seen that the side bars are connected with one another by way of crossbars 7. Side bars 3, 4 and crossbars 7 form a holder 8 for flat screen 2 shown in FIG. 1.

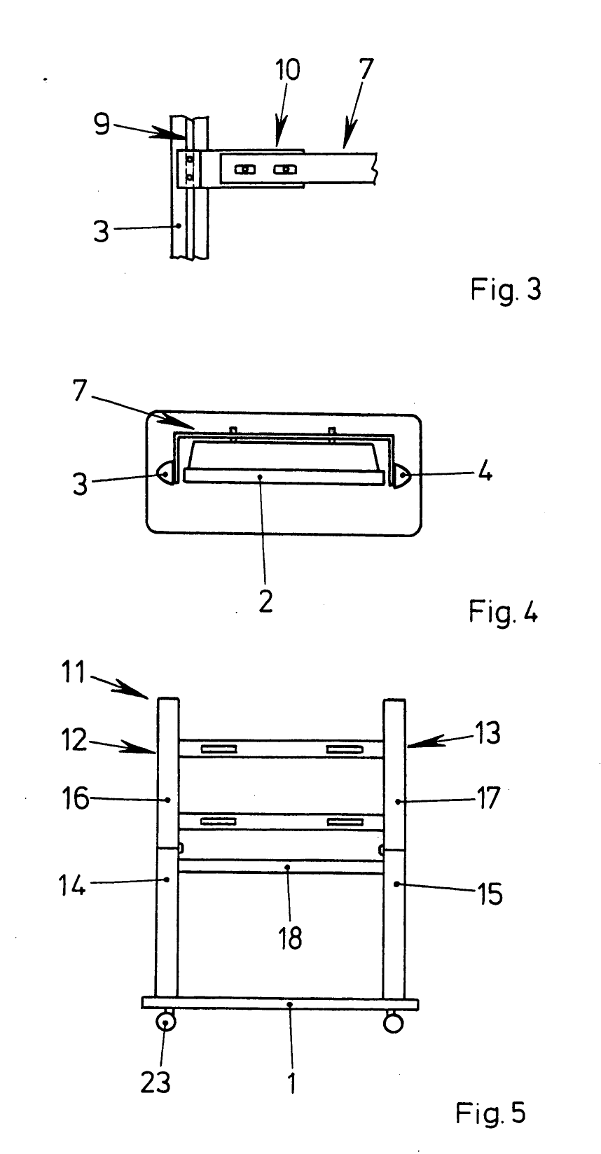

The connection of crossbars 7 to one of side bars 3 from FIG. 2 is shown in FIG. 3, in an enlarged representation. To simplify the drawing, the connection of crossbar 7 is shown in an extended representation, so that the side of the one side bar 3 that faces crossbar 7 can be seen. In this connection, it can be seen that side bar 3 has a longitudinal guide 9 in which crossbar 7 is attached. Crossbar 7 furthermore has adjustment means 10 for its adjustment in length.

FIG. 4 shows a top view of the connection of crossbar 7 to side bars 3, 4 with flat screen 2. In this connection, it can be seen that crossbar 7 holds flat screen 2 in such a manner that it is disposed precisely between side bars 3, 4. The back of the screen stand, and thus the sides of crossbars 7 that face away from flat screen 2, can be covered with a faceplate, not shown.

FIG. 5 shows another embodiment of a holder 11 of the screen stand. This holder 11 has subdivided side bars 12, 13, and thus side-bar sections 14, 15 that lie close to foot 1, and side-bar sections 16, 17 disposed at the level of flat screen 2 shown in FIG. 1. This holder 11 furthermore has another crossbar 18, in comparison with the holder from FIG. 4, which crossbar connects the lower side-bar sections 14, 15 with one another. Foot 1 has rollers 23.

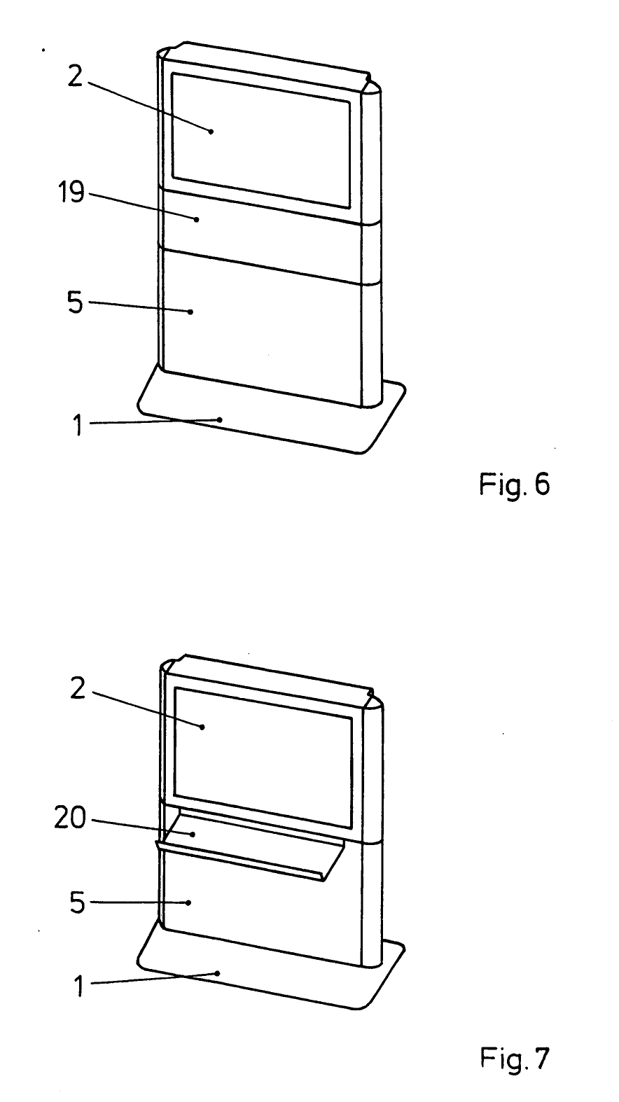

FIG. 6 shows another embodiment of the screen stand, which has a planar intermediate element 19 between faceplate 5 disposed close to the foot and flat screen 2. With this intermediate element 19, it is possible to produce another function of the screen stand, for example, or to adjust the height of flat screen 2.

FIG. 7 shows another embodiment of the screen stand, in which an intermediate element 20 configured as a shelf is disposed between flat screen 2 and faceplate 5 close to foot 1.

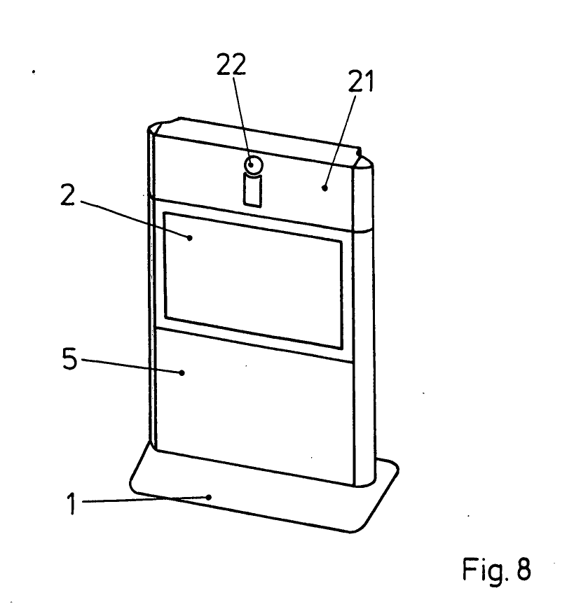

FIG. 8 shows another embodiment of the screen stand, in which a head element 21 is disposed on the top of flat screen 2. Head element 21 has a camera 22.

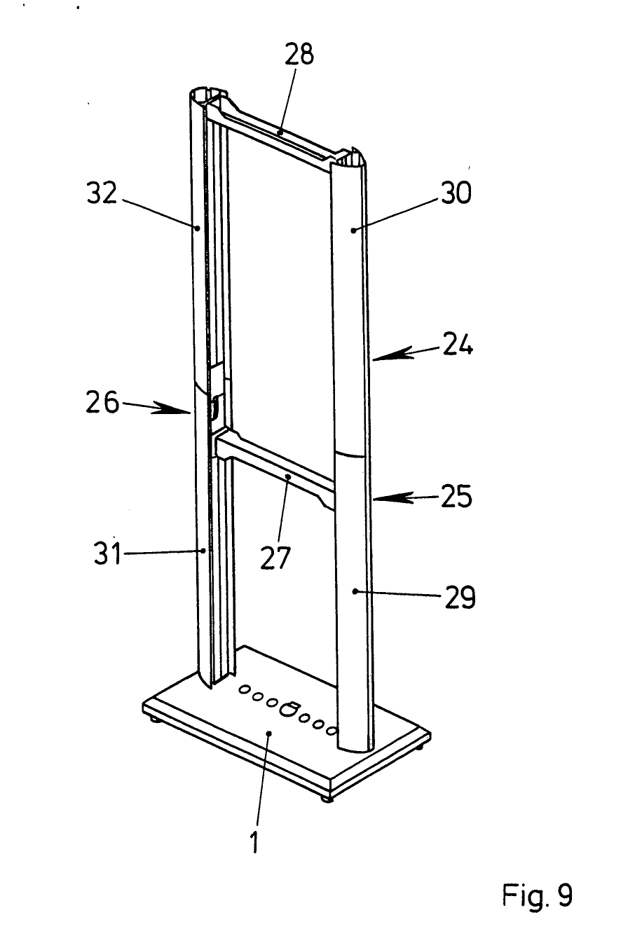

FIG. 9 shows another embodiment of a holder 24 of the screen stand, with two side bars 25, 26 and two crossbars 27, 28. Side bars 25, 26 have side-bar sections 29-31, in each instance.

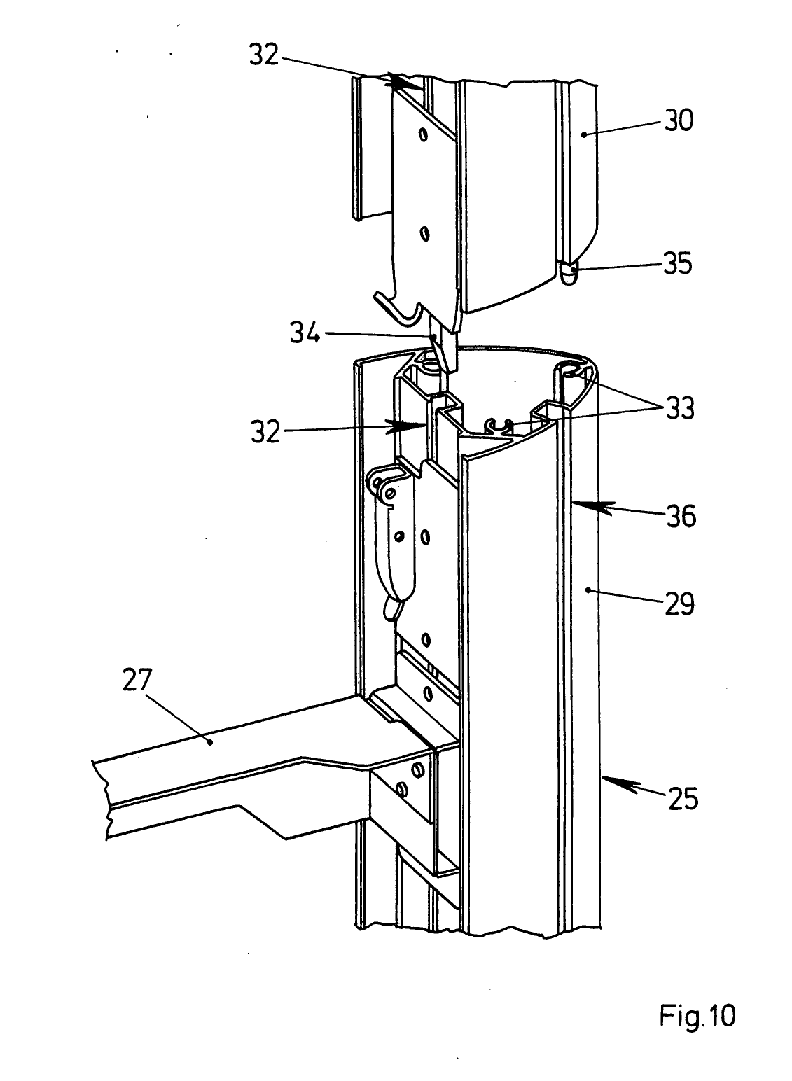

FIG. 10 shows two of the side-bar sections 29, 30 at their connection. Side-bar sections 29, 30 have first longitudinal guides 32 that face crossbar 27, and second longitudinal guides 33 disposed in a box profile. Crossbars 27 are attached in first longitudinal guides 32. Side-bar sections 29, 30 furthermore have pins 34, 35 with which they are connected with one another, by way of first and second longitudinal guides 32, 33. Furthermore, FIG. 10 shows that side bars 25 have a longitudinal groove 36 on the outside, to accommodate a light strip, not shown.

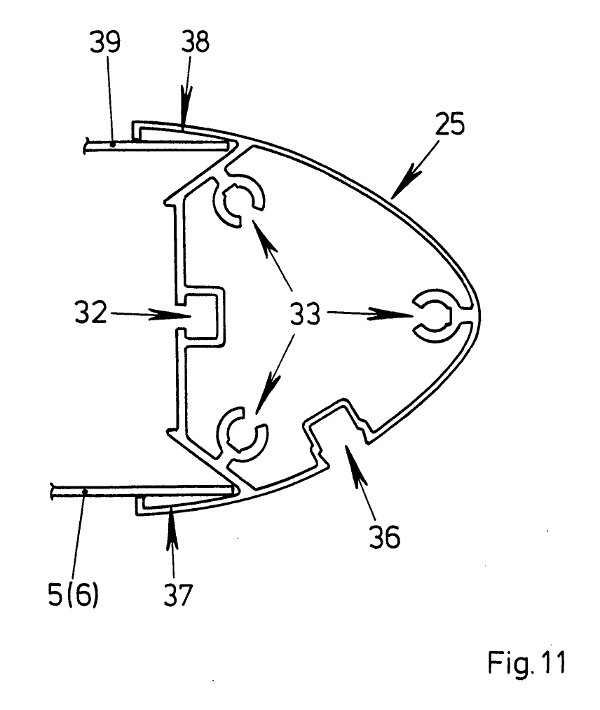

FIG. 11 shows a cross-section of the profile of one of side bars 25 of holder 24 from FIG. 9, with the two longitudinal guides 32, 33 and longitudinal groove 36. Side bar 25 has pockets 37, 38 for accommodating edges of faceplate 5 of frame 6 and a back wall 39 of the screen stand.

Although several embodiments of the present invention have been shown and described, it is to be understood that many changes and modifications may be made thereunto without departing from the spirit and scope of the claims.

What is claimed is:

1. A screen stand comprising:
(a) a flat screen;
(b) a foot;
(c) a holder supporting the flat screen on the foot, said holder comprising first and second side bars laterally enclosing the flat screen and a plurality of crossbars, each crossbar being connected to the first and second side bars; and
(d) a section between said flat screen and said foot comprising a front side and a faceplate on the front side.

2. The screen stand according to claim 1, wherein the faceplate has a display board.

3. The screen stand according to claim 1, wherein each side bar has at least first and second side-bar sections releasably connected with one another, the first side-bar section extending beyond the height of the flat screen and the second side-bar section being connected with the foot.

4. The screen stand according to claim 3, further comprising an intermediate element is inserted between each of the first and second side-bar sections and separating the flat screen from the faceplate disposed underneath the intermediate element.

5. The screen stand according to claim 1, further comprising a head element attached on ends of the first and second side bars facing away from the foot and flush with the flat screen.

6. The screen stand according to claim 1, wherein the crossbars have lengths and positions adjustable relative to the first and second side bars.

7. The screen stand according to claim 1, wherein the first and second side bars have pockets for accommodating edges of at least one of the faceplate, a back wall, and a frame of the flat screen.

8. The screen stand according to claim 1, wherein the first and second side bars have longitudinal guides that face one another, and wherein the crossbars are disposed in the longitudinal guides.

9. The screen stand according to claim 3, further comprising first longitudinal guides and second longitudinal guides, wherein the first and second side bar sections of the first side bar are disposed in at least one of the first longitudinal guides and the second longitudinal guides of the second side bar.

10. The screen stand according to claim 9, wherein the first and second side bars have a closed box profile.

11. The screen stand according to claim 10, wherein the second longitudinal guides are disposed on an inside portion of the box profile of the first and second side bars.

12. The screen stand according to claim 1, wherein the first and second side bars have a longitudinal groove for accommodating a light strip on an outside portion of the first and second side bars.
